(19) United States
(12) Patent Application Publication
(10) Pub. No.: US 2026/0330137 A1
(43) Pub. Date: Oct. 22, 2026

(54) KEYWORD-BASED FALSE POSITIVE DATA AUGMENTATION FOR ENHANCING TOXICITY CLASSIFIER

(71) Applicant: International Business Machines Corporation, Armonk, NY (US)

(72) Inventors: Yang Zhao, Tokyo (JP); Takuma Udagawa, Yamatoshi (JP); Yohei Ikawa, Yokohama-shi (JP); Shalisha Witherspoon, Miami, FL (US); Bishwaranjan Bhattacharjee, Yorktown Heights, NY (US)

(21) Appl. No.: 19/185,596

(22) Filed: Apr. 22, 2025

(51) Int. Cl. G06F 40/263; G06F 40/284

(52) U.S. Cl. CPC G06F 40/263; G06F 40/284

(57) ABSTRACT

A system includes a processor that executes computer executable components stored in a memory. The computer executable components can comprise an input component that obtains an at least one sentence from a toxicity classification model; an identification component that identifies an at least one word in the sentence; a modification component that generates modified versions of the sentence by replacing the identified at least one word with a placeholder; an analysis component that processes the modified sentences through the toxicity classification model to determine variations in classification outputs; a determination component that identifies one or more words contributing to misclassification based on the variations in classification outputs; a generation component that generates an at least one non-toxic sentence incorporating the identified one or more words; and a training component that updates the toxicity classification model with the newly generated at least one non-toxic sentence to improve classification accuracy.

### BACKGROUND

The subject disclosure relates to toxicity classification, e.g., augmenting toxicity classification systems with keyword-based false positive data.

Toxicity classifiers are widely used in various applications to automatically detect and filter harmful or inappropriate content. These classifiers take text as input and produce a binary output, where a label of “1” can indicate that the text is deemed toxic (e.g., offensive, hateful, abusive, or profane), and a label of “0” can indicate that the text is non-toxic. The ability of toxicity classifiers to accurately distinguish between toxic and non-toxic content is crucial for maintaining safe and respectful environments, particularly in social media, content moderation, and automated screening systems.

However, despite advancements in machine learning and natural language processing, toxicity classifiers often suffer from false positive errors. A false positive error occurs when a classifier incorrectly predicts the positive (toxic) class for a text instance that actually belongs to the negative (non-toxic) class. Such errors can not only undermine the reliability of toxicity detection systems but also can negatively impact user experiences and content creators who are unfairly penalized.

Thus, there is a need for improved systems and methods that more accurately identify false positive errors in toxicity classification.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate keyword-based false positive data augmentation for enhanced toxicity classification are provided.

According to an embodiment, a system can comprise a processor that executes computer executable components stored in memory. The computer executable components can comprise an input component that obtains an at least one sentence from a toxicity classification model. The computer executable components can further comprise an identification component that identifies an at least one word in the sentence. The computer executable components can further comprise a modification component that generates modified versions of the sentence by replacing the identified at least one word with a placeholder. The computer executable components can further comprise an analysis component that processes the modified sentences through the toxicity classification model to determine variations in classification outputs. The computer executable components can further comprise a determination component that identifies one or more words contributing to misclassification based on the variations in classification outputs. The computer executable components can further comprise a generation component that generates an at least one non-toxic sentence incorporating the identified one or more words. The computer executable components can further comprise a training component that updates the toxicity classification model with the newly generated at least one non-toxic sentence to improve classification accuracy.

According to another embodiment, a computer-implemented method can comprise obtaining, by a system operatively coupled to a processor, an at least one sentence from a toxicity classification model. The computer-implemented method can comprise identifying, by the system, an at least one word in the sentence. The computer-implemented method can further comprise generating, by the system, modified versions of the sentence by replacing the identified at least one word with a placeholder. The computer implemented method can further comprise processing, by the system, the modified sentences through the toxicity classification model to determine variations in classification outputs. The computer implemented method can further comprise identifying, by the system, one or more words contributing to misclassification based on the variations in classification outputs. The computer implemented method can further comprise generating, by the system, an at least one non-toxic sentence incorporating the identified one or more words. The computer implemented method can further comprise updating, by the system, the toxicity classification model with the newly generated at least one non-toxic sentence to improve classification accuracy.

According to another embodiment, a computer program product comprising a computer readable storage medium having program instructions embodied therewith, the program instructions executable by a processor to cause the processor to obtain, by the processor an at least one sentence from a toxicity classification model. The program instructions can also cause the processor to identify, by the processor, an at least one word in the sentence. The program instructions can also cause the processor to generate, by the processor, modified versions of the sentence by replacing the identified at least one word with a placeholder. The program instructions can also cause the processor to process, by the processor, the modified sentences through the toxicity classification model to determine variations in classification outputs. The program instructions can further cause the processor to identify, by the processor, one or more words contributing to misclassification based on the variations in classification outputs. The program instructions can further cause the processor to generate, by the processor, an at least one non-toxic sentence incorporating the identified one or more words. The program instructions can further cause the processor to update, by the processor, the toxicity classification model with the newly generated at least one non-toxic sentence to improve classification accuracy.

### BRIEF DESCRIPTION OF THE DRAWINGS

FIG. 1 illustrates an example system that can facilitate keyword-based false positive data augmentation for enhanced toxicity classification in accordance with some embodiments described herein.

FIG. 2 illustrates a flow diagram of an example computer implemented method that can facilitate keyword-based false positive data augmentation for enhanced toxicity classification in accordance with some embodiments described herein.

FIG. 3 illustrates results of an example use case demonstrating the effectiveness of the keyword-based false positive data augmentation for enhancing toxicity classification accuracy in accordance with some embodiments described herein.

FIG. 4 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

The increasing prevalence of user-generated content on digital platforms has heightened the need for automated content moderation systems. Toxicity classifiers are one of the primary tools used to detect and filter harmful or inappropriate text. These classifiers analyze input text and produce a binary output: a label of “1” indicates that the text is toxic, while a label of “0” indicates that the text is non-toxic. Toxic content typically encompasses language that is offensive, hateful, abusive, or profane. The accurate identification of such content is crucial for maintaining respectful online environments, particularly in social media, content moderation, and user-generated content platforms.

Despite the widespread adoption of toxicity classifiers, these models often struggle with accuracy, particularly in distinguishing between toxic and non-toxic content. One of the most challenging aspects is the occurrence of false positive errors. A false positive error arises when the toxicity classification model incorrectly predicts the positive (toxic) class for an input instance that actually belongs to the negative (non-toxic) class. The classifier thus inaccurately labels a non-toxic piece of content as toxic. Such errors are not only problematic because they reduce the accuracy of the model, but also because they may lead to unintended consequences, such as unwarranted content removal, unjustified user penalties, or the suppression of benign communication.

One of the primary reasons for false positives in toxicity classifiers is the inherent complexity of human language. Many words and phrases that might appear toxic out of context can have completely non-toxic meanings depending on the specific usage, tone, or cultural context. Moreover, toxicity classifiers often learn biases from training data that disproportionately reflect certain linguistic patterns as toxic. As a result, benign phrases from particular dialects or sociolects may be erroneously classified as harmful. These biases are particularly problematic when the classifier is applied in diverse or global contexts, where language use varies significantly across regions and cultures.

In relation to prevention and correction of false positives in toxicity classifiers, embodiments of the present disclosure produce a solution to one or more of these problems. These embodiments can solve such problems by implementing false positive data augmentation. In the context of toxicity classification, false positive data augmentation can include generating synthetic data that resembles false positive instances, and introducing the generated synthetic data as additional training examples that reflect cases where a model made incorrect positive predictions. False positive data augmentation can assist toxicity classification models in improving identification of toxic and non-toxic content. False positive data augmentation can involve identifying sentences that were wrongly classified as toxic, analyzing the structure and key words that contributed to the false classification, and generating new sentences that incorporate similar patterns but are correctly labeled as non-toxic. This expanded dataset can then be used to fine-tune a toxicity classifier, allowing it to better handle ambiguous or context-dependent inputs.

However, current approaches to false positive data augmentation are often limited in their effectiveness. Many methods lack a systematic way to identify which words or phrases within a sentence are most likely to cause false positive errors. As a result, augmented data can fail to address an underlying problem or can inadvertently introduce noise, diminishing model performance. Additionally, generating synthetic data that realistically captures the nuances of human language can be challenging, leading to limited generalizability and robustness in real-world applications.

To address the problem of false positive errors in toxicity classification, the proposed solution leverages an innovative method for identifying problematic words and generating synthetic training data. The primary objective is to systematically detect the words responsible for false positive errors and augment the training data with carefully generated synthetic instances that mitigate the model's misclassification tendencies. The proposed solution can begin by identifying problematic sentences from a toxicity classification model. Specifically, the proposed method can include obtaining a set of false positive sentences from a model. These sentences can comprise those that the model has mistakenly classified as toxic (e.g., labeled “1”) despite being non-toxic (e.g., labeled “0”). Once the false positive sentences are obtained, the proposed solution can further include analyzing each sentence to identify the specific words that trigger the model's incorrect classification. Each word can be held out in an identified sentence, Each sentence (S) from a set D can be tokenized into a sequence of tokens T₀=[t₁, t₂, . . . , tₙ], accompanied by a sequence of corresponding part-of-speech tags [p₁, p₂, . . . , pₙ]. The solution can include iterating through each token tₖ and determining whether the part-of-speech tag pₖ belongs to one of a set of predefined categories: nouns (NOUN), proper nouns (PROPN), verbs (VERB), adjectives (ADJ), adverbs (ADV), or interjections (INTJ). If a token falls into one of these categories, it can be replaced with a placeholder token <mask>, resulting in a series of modified token sequences T₁, T₂, . . . , Tₘ, where each sequence has one word replaced by <mask>.

After generating modified sequences, the proposed solution can include feeding the original and modified sentences into the toxicity classification model one by one to obtain respective probability outputs: P₀, P₁, P₂, . . . , Pₘ. The original sentence (T₀) can yield a baseline probability P₀, while each modified sentence (T₁ to Tₘ) can produce probabilities P₁ through Pₘ. The probability difference P₀-P₁ (or subsequent differences for other sequences) can indicate how much the toxicity probability decreases after masking a particular word. The word that, when masked, results in the largest decrease in toxicity probability can then be identified as a primary cause of a false positive error. These identified words can be noted as key words and grouped into a keyword set K. For each keyword in the set K, large language models (LLMs) can be employed to generate N non-toxic sentences that contain the identified keyword. These synthetically generated sentences can be subsequently evaluated by the toxicity classification model to determine whether they also result in false positive errors. The generated sentences that continue to trigger false positive classifications can then be retained. The toxicity classification model can b retrained using an enhanced dataset that includes both the original training data and the newly generated false positive cases. By incorporating the synthetic instances, the model can be systematically exposed to nuanced cases that previously led to misclassification.

The herein proposed solution identifies problematic words within false positive instances and generates high-quality synthetic data tailored to address specific classification weaknesses, thereby enhancing the robustness and accuracy of toxicity classification models.

According to an embodiment, a system can include a processor that executes computer executable components stored in memory. The computer executable components can comprise an input component that obtains an at least one sentence from a toxicity classification model. The computer executable components can further comprise an identification component that identifies an at least one word in the sentence. The computer executable components can further comprise a modification component that generates modified versions of the sentence by replacing the identified at least one word with a placeholder. The computer executable components can further comprise an analysis component that processes the modified sentences through the toxicity classification model to determine variations in classification outputs. The computer executable components can further comprise a determination component that identifies one or more words contributing to misclassification based on the variations in classification outputs. The computer executable components can further comprise a generation component that generates an at least one non-toxic sentence incorporating the identified one or more words. The computer executable components can further comprise a training component that updates the toxicity classification model with the newly generated at least one non-toxic sentence to improve classification accuracy.

In some embodiments the identification component can determine the at least one word to modify based on an associated speech tag. The associated speech tag can classify the at least one word as a noun, proper noun, verb, adjective, adverb, or interjection.

In various embodiments, the modification component can iteratively replace the identified at least one word with a placeholder token to generate an at least one modified version of the sentence.

In some embodiments, the analysis component can process the modified versions of the at least one sentence through the toxicity classification model and compute probability differences between classification scores of the original at least one sentence and each modified version of the at least one sentence. The determination component can identify a key word as a primary contributor to misclassification based on a largest probability difference. The generation component can utilize a large language model to generate an at least one new sentence containing the identified key word.

In various embodiments, the training component can update the toxicity classification model by incorporating retained synthetic sentences and corresponding correct toxicity classifications into a training dataset. The training component can apply machine learning techniques to retrain the toxicity classification model using both the original training data and the retained synthetic sentences.

According to some embodiments, the input component can receive a dataset of multiple sentences misclassified as toxic by the toxicity classification model. The input component can also receive a dataset of normal training data comprising multiple sentences correctly classified by the toxicity classification model.

In some embodiments, the determination component can rank identified words based on their impact on the classification score and prioritize higher-ranked words for further processing.

In various embodiments, the modification component can generate at least one modified version of the sentence per identified word and provide the modified sentences in sequential or parallel processing for classification analysis

According to some embodiments, the analysis component can compute classification score differences between the original and modified sentences and apply statistical methods to determine significance.

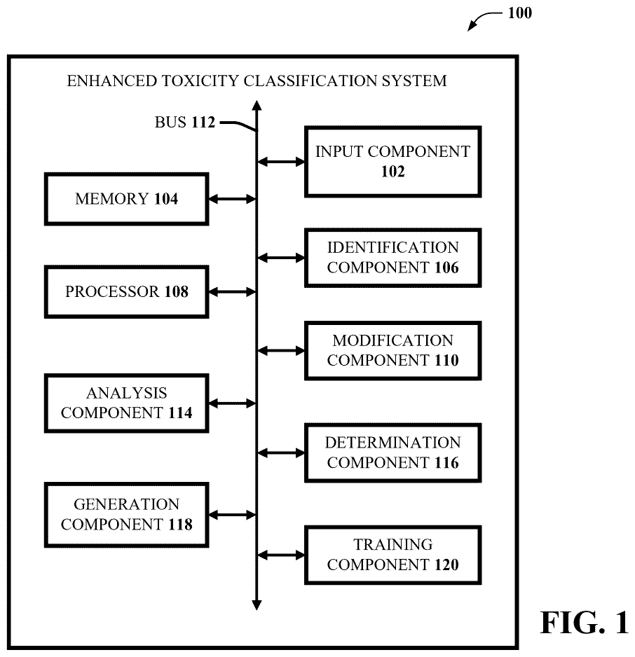

FIG. 1 illustrates an example system 100 for facilitating keyword-based false positive data augmentation for enhanced toxicity classification. The system 100 uses an input component, an identification component, a modification component, an analysis component, a determination component, a generation component, and a training component. The input component can obtain an at least one sentence from a toxicity classification model. The identification component can identify an at least one word in the sentence. The modification component can generate modified versions of the sentence by replacing the identified at least one word with a placeholder. The analysis component can process the modified sentences through the toxicity classification model to determine variations in classification outputs. The determination component can identify one or more words contributing to misclassification based on the variations in classification outputs. The generation component can generate an at least one non-toxic sentence incorporating the identified one or more words. The training component can update the toxicity classification model with the newly generated at least one non-toxic sentence to improve classification accuracy.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 can comprise an input component 102, a memory 104, an identification component 106, a processor 108, a modification component 110, a system bus 112, an analysis component 114, a determination component 116, a generation component 118, and a training component 120.

The system 100 and/or the components of the system 100 may use hardware and/or software to solve problems that are highly technical in nature. The system 100 solves problems that are not abstract and that cannot be performed as a set of mental acts by a human. Further, some of the processes can be performed by specialized computers for carrying out defined tasks related to keyword-based false positive data augmentation for enhanced toxicity classification. The system 100 and/or components of the system 100 can be employed to solve new problems that arise through advancements in technologies. The system 100 can provide technical improvements to keyword-based false positive data augmentation for enhanced toxicity classification by systematically identifying problematic words that lead to false positive errors and generating synthetic non-toxic sentences incorporating these keywords.

The system 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that may be operably connected to the processor 108. The memory 104 can store computer-executable instructions that, upon execution by the processor 108, can cause the processor 108 and/or one or more other components of the system 100 (e.g., the input component 102, the identification component 106, the modification component 110, the analysis component 114, the determination component 116, the generation component 118, and/or the training component 120) to perform one or more actions. In some embodiments, the memory 104 can store computer-executable components (e.g., the input component 102, the identification component 106, the modification component 110, the analysis component 114, the determination component 116, the generation component 118, and/or the training component 120).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that may employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the input component 102 can obtain an at least one sentence from a toxicity classification model. The input component 102 can be configured to interface with one or more toxicity classification models to access sentences that have been processed and classified. The input component 102 can retrieve both individual sentences and collections of sentences that have been classified as toxic or non-toxic by the model. The input component 102 can receive a dataset of multiple sentences that have been misclassified as toxic by the toxicity classification model. These false positive sentences can include instances where the model incorrectly assigned a toxic label to text that is, in fact, non-toxic. The input component 102 can aggregate these misclassified sentences into a structured dataset, facilitating the systematic examination and correction of the model's false positive errors. The input component 102 can be configured to regularly update this dataset as the toxicity classification model processes new inputs, thereby maintaining an up-to-date collection of problematic cases. In addition to receiving misclassified sentences, the input component 102 can also obtain a dataset of normal training data comprising multiple sentences correctly classified by the toxicity classification model. The input component 102 can differentiate between the false positive dataset and the normal training data, storing them in distinct data structures to facilitate targeted processing and analysis. The input component 102 can further support integration with various data sources, including local storage, databases, or external APIs. The input component 102 can preprocess the received sentences to ensure compatibility with subsequent processing components.

According to some embodiments, the identification component 106 can identify an at least one word in the sentence. In various embodiments, the identification component 106 can analyze the structure of the sentence to determine which words are most relevant for subsequent processing. This identification process can involve parsing the sentence and examining each word individually to extract linguistic and contextual features that may influence the toxicity classification outcome. The identification component 106 can determine the at least one word to modify based on an associated part-of-speech (POS) tag. The identification component 106 can tokenize the sentence into individual words and then assign a POS tag to each word using natural language processing (NLP) techniques. The identification component 106 can utilize a POS tagging algorithm to categorize each word according to its grammatical role within the sentence. The associated POS tag can classify the identified word as a noun, proper noun, verb, adjective, adverb, or interjection. By focusing on these specific word categories, the identification component 106 can effectively isolate the elements of the sentence that are most likely to influence the toxicity classification model's decision. the identification component 106 can use linguistic heuristics or machine learning techniques to improve the accuracy of word identification. For instance, the component 106 can analyze the syntactic structure and context surrounding each word to better understand its significance. In some embodiments, the identification component 106 can be configured to prioritize certain word types or contextual clues when determining which words to mask or modify.

According to some embodiments, the modification component 110 can generate modified versions of the sentence by replacing the identified at least one word with a placeholder. The modification component 110 can dynamically apply this transformation to any sentence retrieved from the input component 102, thereby creating new variations of the original text for further analysis. According to some embodiments, the modification component 110 can iteratively replace the identified at least one word with a placeholder token to generate at least one modified version of the sentence. The modification component 110 can generate at least one modified version of the sentence per identified word and can efficiently provide the modified sentences in sequential or parallel processing for classification analysis. In sequential processing, the modified sentences can be generated and analyzed one after another. In parallel processing, the modification component 110 can simultaneously produce multiple modified sentences and send them for classification analysis without delay. In some embodiments, the modification component 110 can employ various placeholder tokens based on linguistic context or predefined criteria. For instance, it can use a generic token, such as <mask>, to indicate the replaced word, or it can select a contextually appropriate substitute. The modification component 110 can be configured to store both the original sentence and its modified versions in a structured format, allowing other system components, such as the analysis component 114, to easily access and compare the different versions.

According to some embodiments, the analysis component 114 can process the modified sentences through the toxicity classification model to determine variations in classification outputs. By analyzing these variations, the analysis component 114 can identify words or phrases that disproportionately influence the model's decision, thereby isolating potential causes of false positive errors. According to some embodiments, the analysis component 114 can process the modified versions of the at least one sentence through the toxicity classification model and compute probability differences between the classification scores of the original sentence and each modified version. The analysis component 114 can submit the original sentence (without modification) to the model to obtain a baseline classification score (P₀). The analysis component 114 can then submit each modified version (where one word is replaced by a placeholder) to obtain corresponding scores (P₁, P₂, . . . , Pₘ). The analysis component 114 can calculate the difference between the original classification score and each modified version's score. These differences can reflect the impact of specific word replacements on the model's toxicity prediction. The analysis component 114 can compute classification score differences between the original and modified sentences and apply statistical methods to determine the significance of these differences. By using statistical analysis, the component 114 can differentiate between meaningful changes in classification output and variations that are likely due to noise or random fluctuations. In some embodiments, the analysis component 114 can rank the identified words based on the magnitude of the probability difference. Words that, when replaced, lead to the most significant decrease in toxicity probability can be prioritized as potential causes of false positive errors. The analysis component 114 can be configured to store and organize the analysis results for each sentence and its modifications.

In certain embodiments, the determination component 116 can identify one or more words contributing to misclassification based on the variations in classification outputs obtained from the analysis component 114. By evaluating the differences in classification scores between the original sentence and its modified versions, the determination component 116 can systematically pinpoint the specific words that are most likely responsible for triggering false positive errors. In certain embodiments, the determination component 116 can identify a key word as the primary contributor to misclassification based on the largest probability difference. After receiving the classification score differences from the analysis component 114, the determination component 116 can compare these values to identify the most impactful word. The word associated with the largest decrease in toxicity probability when replaced by a placeholder can be selected as the key word. The determination component 116 can also rank identified words based on their impact on the classification score. The determination component 116 can order words according to the magnitude of the probability difference observed when each word is replaced. Words that cause the most significant reduction in the model's toxicity score when masked can be ranked higher, while words with minimal impact can be ranked lower. In some embodiments, the determination component 116 can utilize statistical significance measures to validate the ranking of words. The determination component 116 can output the ranked list of key words for use by other system components.

In some embodiments, the generation component 118 can generate an at least one non-toxic sentence incorporating the identified one or more words. The generation component 118 can create new examples that can help the toxicity classification model learn from its previous false positive errors. In some embodiments, the generation component 118 can utilize large language models (LLMs) or other natural language generation techniques to produce synthetic sentences. These generated sentences can be intentionally crafted to be non-toxic while containing the key words identified as contributing to false positive errors. The generation component 118 can prompt the LLM with templates, contexts, or sentence structures that maintain a benign or positive tone while naturally incorporating the target word. The generation component 118 can generate multiple variations of non-toxic sentences for each identified key word to ensure diversity in the training data. By generating a wide range of non-toxic sentences, the generation component 118 can minimize the risk of overfitting to a narrow set of examples. The component 118 can ensure that the generated sentences are contextually accurate and grammatically correct to maintain the quality of the augmented training data. the generation component 118 can be configured to automatically filter out any generated sentences that inadvertently exhibit toxic characteristics. After generation, the component 118 can pass the new sentences through the toxicity classification model to verify that they are correctly classified as non-toxic. Sentences that consistently receive a non-toxic label can be retained for further processing.

In various embodiments, the training component 120 can update the toxicity classification model with the newly generated at least one non-toxic sentence to improve classification accuracy. The training component 120 can update the toxicity classification model by incorporating retained synthetic sentences and corresponding correct toxicity classifications into a training dataset. The training component 120 can organize the augmented data alongside the original training data to maintain a balanced and representative dataset. The training component 120 can apply machine learning techniques to retrain the toxicity classification model using both the original training data and the retained synthetic sentences. The training component 120 can utilize various machine learning algorithms, such as supervised learning or fine-tuning techniques, to optimize the model's classification performance. The training component 120 can monitor the model's performance during the retraining process to detect any overfitting or degradation in accuracy. If the model's performance does not improve or worsens, the training component 120 can initiate additional fine-tuning or data augmentation to address identified issues. The training component 120 can generate performance metrics after the model update, comparing the model's accuracy, precision, recall, and false positive rate before and after incorporating the synthetic data.

The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

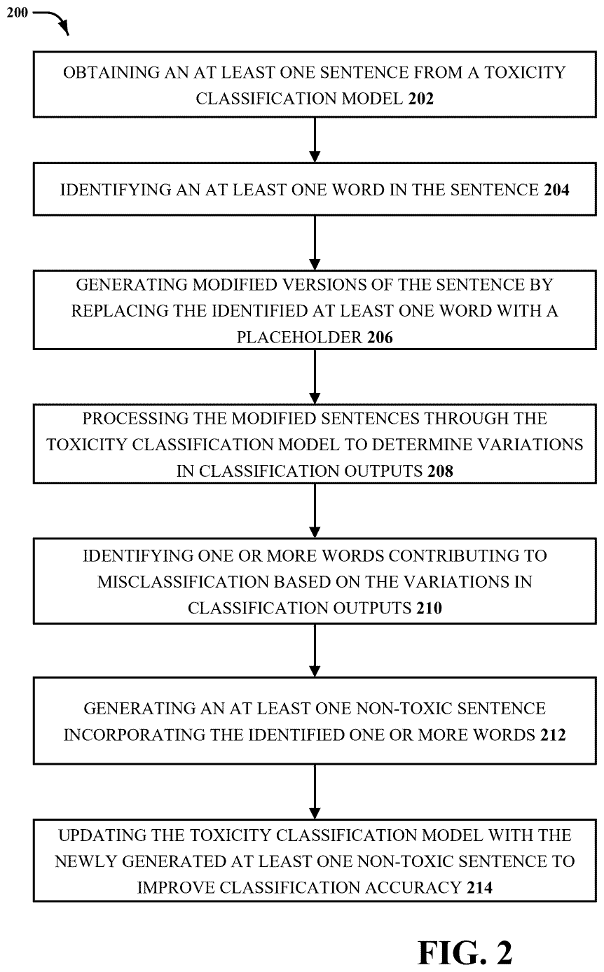

FIG. 2 illustrates an example keyword-based false positive data augmentation flow diagram 300 that can facilitate keyword-based false positive data augmentation for enhanced toxicity classification.

The flow diagram 200 starts by obtaining 202 an at least one sentence from a toxicity classification model. This step can be performed by accessing data from the model's output, logs, or real-time data feeds where sentences have been processed and classified. Step 202 can focus on identifying sentences that have been labeled as toxic (output of “1”) but are actually non-toxic false positives. Step 202 can further comprise obtaining a dataset of multiple sentences that includes both misclassified toxic sentences and correctly classified non-toxic sentences. The obtained sentences can be sourced from various databases, model logs, or streaming data from active applications, ensuring that the data remains current and relevant for the model's intended use.

The flow diagram 200 continues by identifying 204 an at least one word in the sentence. Step 204 can use natural language processing (NLP) techniques to tokenize the sentence, breaking it into individual words or tokens. Step 204 can further comprise determining the identified word based on its associated part-of-speech (POS) tag. Specifically, step 204 can include classifying the identified word as a noun, proper noun, verb, adjective, adverb, or interjection.

The flow diagram 200 continues by generating 206 modified versions of the sentence by replacing the identified at least one word with a placeholder. This placeholder can be a standardized marker, such as <mask>, that indicates where the original word was replaced. Step 206 can include generating modified sentences by systematically replacing each identified word while keeping the rest of the sentence unchanged. Step 206 can further comprise iteratively replacing each identified word with the placeholder to create a set of modified sentences. Each version can differ by having only one word replaced at a time, allowing the system to isolate the impact of each word on the model's classification decision. Step 206 can also include generating at least one modified version per identified word, ensuring comprehensive coverage of all potentially problematic terms. The method 200 can also support processing these modified sentences sequentially or in parallel to optimize analysis efficiency.

The flow diagram 200 continues by processing 208 the modified sentences through the toxicity classification model to determine variations in classification outputs. Step 208 can involve feeding each modified sentence into the model to obtain new classification scores. Step 208 can further comprise calculating the difference between the original sentence's classification score and each modified version's score. These calculated differences can help quantify the influence of specific words on the model's false positive errors. Step 208 can also include storing the classification scores and their differences to facilitate further analysis and comparison.

The flow diagram 200 continues by identifying 210 one or more words contributing to misclassification based on the variations in classification outputs. Step 210 can further comprise identifying the word associated with the largest decrease in toxicity probability when replaced with a placeholder. This identified word can be marked as a primary contributor to the false positive error. Step 210 can also involve ranking the identified words based on the magnitude of their impact on the classification score. Higher-ranked words can be prioritized for further processing, ensuring that the system efficiently addresses the most problematic terms in the dataset.

The flow diagram 200 continues by generating 212 an at least one non-toxic sentence incorporating the identified one or more words. 212 can include utilizing language generation models, such as large language models (LLMs), to create synthetic sentences that include the problematic keywords while maintaining a non-toxic context. These generated sentences can challenge the model's previous misclassification tendencies by demonstrating non-toxic usage of the identified words. Step 212 can further comprise generating multiple non-toxic sentences for each identified keyword to ensure diversity in the augmented training data. Step 212 can further involve verifying the non-toxicity of generated sentences by processing them through the toxicity classification model.

The flow diagram 200 continues by updating 214 the toxicity classification model with the newly generated at least one non-toxic sentence to improve classification accuracy. 214 can include integrating the retained synthetic sentences into the model's training dataset, combining them with the original data to create an enhanced training set. Step 214 can further comprise applying machine learning techniques to retrain the model using both the original training data and the augmented synthetic sentences. Techniques such as fine-tuning or batch training can be applied to optimize model performance. Step 214 can also include validating the updated model by assessing its performance on a test dataset to ensure that incorporating the synthetic data has improved its accuracy and reduced false positive rates.

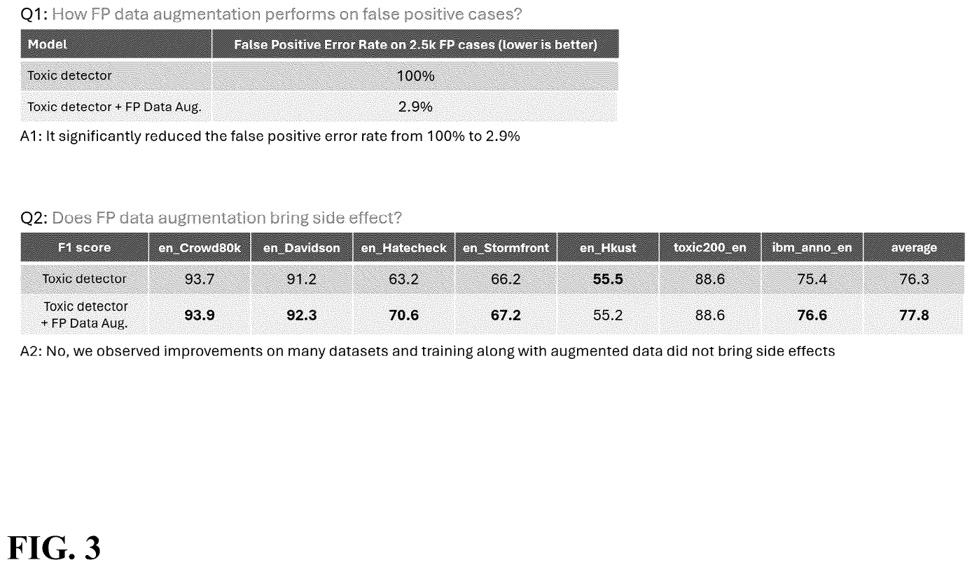

Next, FIG. 3 illustrates results of an example use case for implementing a multilingual toxicity classification model with false positive data augmentation to enhance model accuracy in accordance with various embodiments described herein. FIG. 3 showcases quantitative results from an experimental implementation demonstrating a reduction in false positive errors and an absence of negative side effects when incorporating augmented data. The example use case can involve utilizing a multilingual model as the base model for toxicity classification. Selecting a multilingual model can enable the system to process text data from various languages, making it suitable for applications that require global content moderation. This model can be fine-tuned using data from multiple sources to maximize its generalization capabilities across different linguistic contexts. To evaluate the effectiveness of false positive data augmentation, the example can involve selecting a set D of false positive sentences from the development set of all benchmark datasets. In the example use case, approximately 100 keywords can be identified from the false positive sentences. Using these keywords, around 300 non-toxic sentences can be generated for each keyword, resulting in a total of 30,000 augmented sentences. From this augmented set, approximately 2,500 sentences that still trigger false positive classifications can be retained for retraining. The quantitative results from this example use case can demonstrate the significant impact of false positive data augmentation on model performance. By using a multilingual model and incorporating targeted false positive data augmentation, the example use case shown in FIG. 3 can illustrate the practical benefits of the approach. Such improvements can help enhance toxicity classification systems by making them more accurate and less prone to false positive errors, particularly when processing diverse and nuanced language inputs.

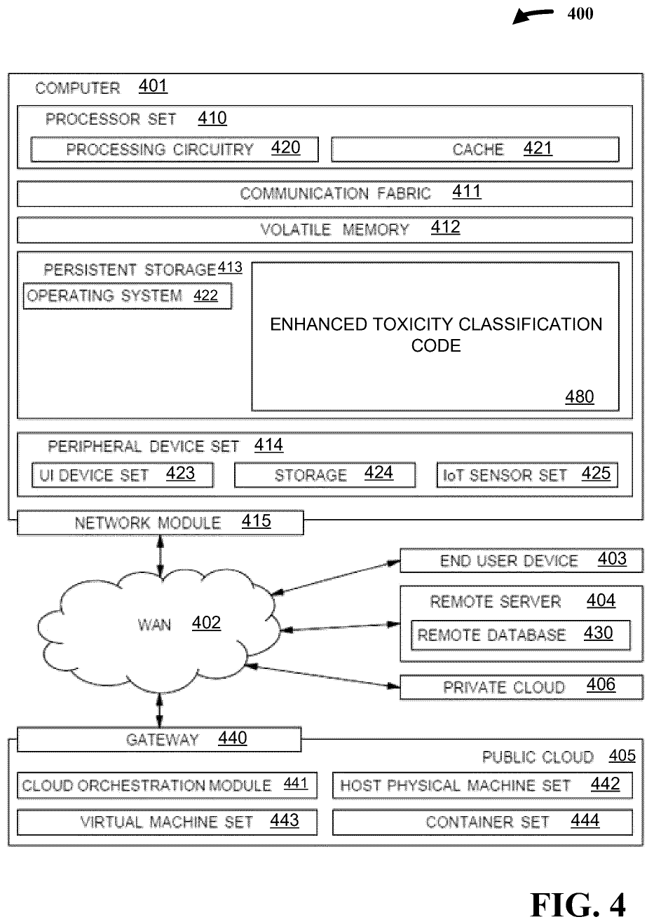

FIG. 4 and the following discussion are intended to provide a brief, general description of a suitable computing environment 400 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as iteratively updating the preliminary recovery plan until a failure-free recovery plan is developed with enhanced toxicity classification code 480. In addition to block 480, computing environment 400 includes, for example, computer 401, wide area network (WAN) 402, end user device (EUD) 403, remote server 404, public cloud 405, and private cloud 406. In this embodiment, computer 401 includes processor set 414 (including processing circuitry 420 and cache 421), communication fabric 411, volatile memory 412, persistent storage 413 (including operating system 422 and block 445, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method can be distributed among multiple computers and/or between multiple locations. On the other hand, in this presentation of computing environment 400, detailed discussion is focused on a single computer, specifically computer 401, to keep the presentation as simple as possible. Computer 401 can be located in a cloud, even though it is not shown in a cloud in FIG. 4. On the other hand, computer 401 is not required to be in a cloud except to any extent as can be affirmatively indicated.

PROCESSOR SET 410 includes one, or more, computer processors of any type now known or to be developed in the future. Processing circuitry 420 can be distributed over multiple packages, for example, multiple, coordinated integrated circuit chips. Processing circuitry 420 can implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set can be located “off chip.” In some computing environments, processor set 410 can be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods can be stored in block 445 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory can be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 can be a read only memory (ROM), but typically at least a portion of the persistent storage allows writing of data, deletion of data and re-writing of data. Some familiar forms of persistent storage include magnetic disks and solid-state storage devices. Operating system 422 can take several forms, such as various known proprietary operating systems or open-source Portable Operating System Interface type operating systems that employ a kernel. The code included in block 445 typically includes at least some of the computer code involved in performing the inventive methods.

PERIPHERAL DEVICE SET 414 includes the set of peripheral devices of computer 401. Data communication connections between the peripheral devices and the other components of computer 401 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 can include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 can be persistent and/or volatile. In some embodiments, storage 424 can take the form of a quantum computing storage device for storing data in the form of qubits. In embodiments where computer 401 is required to have a large amount of storage (for example, where computer 401 locally stores and manages a large database) then this storage can be provided by peripheral storage devices designed for storing large amounts of data, such as a storage area network (SAN) that is shared by multiple, geographically distributed computers. IoT sensor set 425 is made up of sensors that can be used in Internet of Things applications. For example, one sensor can be a thermometer, and another sensor can be a motion detector.

NETWORK MODULE 415 is the collection of computer software, hardware, and firmware that allows computer 401 to communicate with other computers through WAN 402. Network module 415 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401) and can take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 can be a client device, such as thin client, heavy client, mainframe computer and/or desktop computer.

REMOTE SERVER 404 is any computer system that serves at least some data and/or functionality to computer 401. Remote server 404 can be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data can be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs can be stored as images and can be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware and firmware allowing public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 475 and private cloud 476 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
an input component that obtains an at least one sentence from a toxicity classification model;
an identification component that identifies an at least one word in the sentence;
a modification component that generates modified versions of the sentence by replacing the identified at least one word with a placeholder;
an analysis component that processes the modified sentences through the toxicity classification model to determine variations in classification outputs;
a determination component that identifies one or more words contributing to misclassification based on the variations in classification outputs;
a generation component that generates an at least one non-toxic sentence incorporating the identified one or more words; and
a training component that updates the toxicity classification model with the newly generated at least one non-toxic sentence to improve classification accuracy.

2. The system of claim 1, wherein the identification component determines the at least one word to modify based on an associated speech tag.

3. The system of claim 2, wherein the associated speech tag classified the at least one word as a noun, proper noun, verb, adjective, adverb, or interjection.

4. The system of claim 1, wherein the modification component iteratively replaces the identified at least one word with a placeholder token to generate an at least one modified version of the sentence.

5. The system of claim 1, wherein the analysis component processes the modified versions of the at least one sentence through the toxicity classification model and computes probability differences between classification scores of the original at least one sentence and each modified version of the at least one sentence.

6. The system of claim 5, wherein the determination component ranks identified words based on their impact on the classification score and prioritizes higher-ranked words for further processing.

7. The system of claim 5, wherein the determination component identifies a key word as a primary contributor to misclassification based on a largest probability difference.

8. The system of claim 7, wherein the generation component utilizes a large language model to generate an at least one new sentence containing the identified key word.

9. The system of claim 1, wherein the training component updates the toxicity classification model by incorporating retained synthetic sentences and corresponding correct toxicity classifications into a training dataset.

10. The system of claim 9, wherein the training component applies machine learning techniques to retrain the toxicity classification model using both the original training data and the retained synthetic sentences.

11. The system of claim 1, wherein the input component receives a dataset of multiple sentences misclassified as toxic by the toxicity classification model.

12. The system of claim 1, wherein the input component receives a dataset of normal training data comprising multiple sentences correctly classified by the toxicity classification model.

13. The system of claim 1, wherein the modification component generates at least one modified version of the sentence per identified word and provides the modified sentences in sequential or parallel processing for classification analysis.

14. The system of claim 1, wherein the analysis component computes classification score differences between the original and modified sentences and applies statistical methods to determine significance.

15. A computer-implemented method that utilizes a processor that executes computer executable components stored in memory to perform the following acts:
obtaining an at least one sentence from a toxicity classification model;
identifying an at least one word in the sentence;
generating modified versions of the sentence by replacing the identified at least one word with a placeholder;
processing the modified sentences through the toxicity classification model to determine variations in classification outputs;
identifying one or more words contributing to misclassification based on the variations in classification outputs; and
generating an at least one non-toxic sentence incorporating the identified one or more words;
updating the toxicity classification model with the newly generated at least one non-toxic sentence to improve classification accuracy.

16. The method of claim 15, wherein the identifying the at least one word in the sentence further comprises selecting an at least one word based on a speech classification.

17. The method of claim 15, wherein the generating modified versions of the sentence further comprises iteratively replacing the identified at least one word with a placeholder token to produce multiple variations of the sentence.

18. The method of claim 15, wherein the identifying one or more words contributing to misclassification further comprises computing a difference between a classification probability of the original sentence and a classification probabilities of the modified versions, and selecting an at least one word associated with a large probability difference.

19. The method of claim 16, wherein the updating the toxicity classification model further comprises retraining the model using both an original training dataset and retained synthetic sentences with corresponding correct toxicity classifications.

20. A computer program product comprising a computer readable storage medium having program instructions embodied therewith, the program instructions executable by a processor to cause the processor to:
obtain an at least one sentence from a toxicity classification model;
identify an at least one word in the sentence;
generate modified versions of the sentence by replacing the identified at least one word with a placeholder;
process the modified sentences through the toxicity classification model to determine variations in classification outputs;
identify one or more words contributing to misclassification based on the variations in classification outputs;
generate an at least one non-toxic sentence incorporating the identified one or more words; and
update the toxicity classification model with the newly generated at least one non-toxic sentence to improve classification accuracy.
